(19) United States
(12) Patent Application Publication
(10) Pub. No.: US 2003/0090145 A1
(43) Pub. Date: May 15, 2003

(54) Device to control a brake arrangement and a brake system for a heavy vehicle with such a brake arrangement

(76) Inventors: Hakan Andersson, Sodertalje (SE); Peter Engelke, Sodertalje (SE); Nils-Gunnar Vagstedt, Taby (SE); Lars-Gunnar Hedstrom, Vagnharad (SE); Gianantonio Bortolin, Frovi (SE); Per-Olof Gutman, Haifa (IL)

Correspondence Address: OSTROLENK FABER GERB & SOFFEN, 1180 AVENUE OF THE AMERICAS, NEW YORK, NY, 100368403

(21) Appl. No.: 10/168,010

(22) PCT Filed: Dec. 13, 2000
(86) PCT No.: PCT/SE00/02508

(30) Foreign Application Priority Data
Dec. 13, 1999 (SE) 9904556-9

(51) Int. Cl. B60T 13/00

(52) U.S. Cl. 303/9; 188/346

(57) ABSTRACT

The invention relates to a device for controlling a braking arrangement on a heavy vehicle. The braking arrangement comprises a main brake, which includes braking devices (1a -f), for example disc brakes, that are each arranged to act on one of the vehicle wheels (2a-f). Furthermore, the braking arrangement comprises at least one auxiliary brake (3) and a brake control (10) with which the named main brake (1a-f) and auxiliary brake (3) are activated. When a driver activates the brake control (10), a control unit (9) in the arrangement is arranged to initiate activation of the main brakes (1a-f) and the auxiliary brake (3) and thus distributes the braking effect between these brakes in such a way that the braking effect requested by the driver is obtained in the shortest possible time and in such a way that the use of the brake devices (1a-f) of the main brake is minimised after an initial period. The invention relates to a braking system for a heavy vehicle, which comprises an arrangement described above.

### BACKGROUND OF THE INVENTION AND STATE OF THE ART

This invention relates to a device for controlling a brake arrangement on a heavy vehicle according to patent claim 1.

The brakes on heavy vehicles, for example trucks, function using wheel brakes, which can for example be drum brakes or disc brakes.

When the brakes are applied for a long period, such as when descending a long hill, there is a risk of so-called heat fading, i.e. a reduction in the braking effect because the brake linings become very heated. The wheel brakes on heavy vehicles are usually applied using compressed air and if the wheel brakes are often released and applied during a long period of braking, the requirements on the air system are stringent. There is a risk that the air control pressure can drop, which results in a reduction in the braking effect. On traditional trucks the air passes from a reservoir to the brake chambers at a pressure that is decided by the force exerted on the brake pedal by the driver. On newer truck models the main brakes are controlled by EBS, Electronic Braking System, where the pressure on the brake pedal is sensed electrically.

With the object of diminishing the above mentioned risks, extra auxiliary brakes have been developed which are applied independently of the wheel brakes. The auxiliary brakes can be applied for long periods thus allowing the brake linings of the wheel brakes to be kept cold for emergency situations or heavy braking. Furthermore, the auxiliary brakes can be applied for long periods without any overheating.

The retarder is an auxiliary brake of this type, in particular the type of retarder that generates a braking torque using viscous friction, for example, using oil between a stator and a rotor. The retarder can be connected to the propeller shaft of the heavy vehicle and thus apply a braking torque to the shaft which is transferred to the driven wheels of the heavy vehicle. The braking power of the retarder increases as the speed of the propeller shaft increases and the time before the retarder starts to apply the braking torque depends on previous applications of the retarder. Before the retarder starts to produce an outgoing braking torque, the space between the stator and the rotor must be filled with oil. The retarder can contain a pump and an oil reservoir. The lower the speed of the propeller shaft of the heavy vehicle, the longer time it takes to fill the space between the stator and rotor. An oil accumulator connected to the oil reservoir is often used to quicken this operation. One problem with the retarder is that the driver experiences the long and varied time before application of the retarder as inconvenient.

Another example of an auxiliary brake is the exhaust brake, which is mounted in the exhaust pipe and is thus connected to the engine of the heavy vehicle. The exhaust brake contains some type of valve device than can be arranged to be operated by a pneumatic cylinder. The function of the exhaust brake is to increase the natural braking effect of the engine. The braking torque produced by the exhaust brake depends on the type of engine and the current gear on the vehicle. The exhaust brake is effective in the lower gears. Another auxiliary brake that increases the natural braking effect of the engine is the compression brake, often called the “lake brake”.

As mentioned earlier, the brakes above, i.e. the wheel brakes and the auxiliary brakes, function independently of each other. These brakes can have separate controls. However, on some trucks the wheel brakes and the retarder are activated using the same pedal. When the driver depresses the brake pedal, the retarder is activated first, which corresponds to a little slack in the pedal movement. After this the wheel brakes are activated. However, this solution is unsatisfactory because a long time is needed to activate the retarder and the time can vary. There can be a time delay of several seconds before the retarder generates an outgoing braking torque. The driver can experience this delay in response as unsatisfactory and as a result the driver may press the brake pedal even harder, which can lead to an unnecessarily large braking effect, so-called over-braking.

### SUMMARY OF INVENTION

The object of the invention is to eliminate the above mentioned problem. In particular the invention is aiming at a device and a braking system which contribute towards a fast braking response when the driver requests a braking effect. Furthermore, the invention is aiming at a device and a braking effect which contribute towards a reduction in brake lining wear on the wheel brakes.

This object is achieved with the device described in the introduction, which is characterised by the features specified in the characterised part to patent claim 1. The device is thus arranged to communicate with the brake control mentioned. When a driver activates a brake control, for example by depressing a brake pedal, a signal is transmitted to the mentioned control unit on the device, which can include a computer, and the control unit initiates activation of the main brake, i.e. the wheel brakes, and the auxiliary brake, which is preferably the retarder, and thus the braking effect is distributed between the main brake and the auxiliary brake. The distribution mentioned provides a fast outgoing braking torque that retards the vehicle, which the driver experiences as satisfactory.

According to a preferred embodiment of the invention, the control unit is arranged to distribute essentially the whole of the braking effect to the above mentioned braking devices on the main brake during an initial period of the activation mentioned. The above mentioned braking devices, which are each arranged to operate on one wheel of the vehicle, can comprise disc brakes or drum brakes. As the braking devices quickly generate an outgoing braking torque, the largest braking effect is thus distributed to these at the beginning of the vehicle's braking.

According to another preferred embodiment of the invention, the control device is arranged in such a way that the utilisation of the braking device on the mentioned main brake is minimal after the initial period. The control unit is thus arranged to distribute the largest braking effect to the named main brakes while the auxiliary brake mentioned is being applied, and after this the distribution of the braking effect to the main brakes is reduced. After the mentioned initial period, the control unit has the possibility of distributing the whole of the braking effect to the mentioned auxiliary brake and the main brakes are thus inactive. In this way the temperature of the wheel brake linings can be kept down and the wheel brakes are thus prepared for emergency situations or heavy braking requirements.

According to another preferred embodiment of the invention, the control device is arranged in such a way that the sum of the braking effect from the mentioned main brake and the braking effect from the mentioned auxiliary brake essentially corresponds to a reference value. In this way a device is obtained, that makes the braking effect from the mentioned main brake and at least the mentioned auxiliary brake follow a reference value, i.e. follow a desired braking effect signal. The control unit thus contains the equipment and the algorithms needed so that the braking effect follows a desired braking effect signal. With the object of obtaining the desired braking effect quickly, the control unit is arranged, as described above, to distribute the largest braking effect to the main brake during the initial period of the activation mentioned. As the outgoing braking effect of the auxiliary brake increases, the braking effect of the main brake decreases. After a certain time and depending on the reference value, the auxiliary brake can take on the total braking effect by itself. In this way the brake linings of the main brake can be kept cold for emergency situations or when heavy braking is required.

According to another preferred embodiment of the invention, the brake control is arranged in such a way to define the reference value mentioned. The control unit of the device is thus arranged to communicate with the mentioned brake control to obtain the reference value mentioned, i.e. the desired braking effect signal. According to a preferred embodiment, when applied the brake control mentioned above is movable against the effect of a flexible force that is essentially proportional to the named reference value. The device can thus include means of sensing the force mentioned. This sensing can be implemented continuously.

According to another preferred embodiment of the invention, the device includes means of sensing the vehicle's retardation and the retardation is arranged to provide feedback to the named control unit, and the control unit is arranged to compare the retardation of the vehicle to the named reference value. The braking process is thus controlled in a closed loop, i.e. the distribution of the braking effect, where the reference value is the control signal and the feedback signal is the measured value. According to this preferred embodiment, the means of sensing is arranged to measure changes in vehicle speed and the reference value is equivalent to the desired retardation of the vehicle. It should be noted that the vehicle's retardation can be sensed via the vehicle's ABS sensors. It should also be noted that the means of sensing can be arranged to sense the total outgoing braking torque, i.e. the braking torque from the named main brake and the braking torque from at least the named auxiliary brake, in doing which the control unit is arranged to compare the fed back braking torque with the desired outgoing braking torque. It is also possible to arrange the means of sensing so that it senses the vehicle speed, in doing which the total braking torque can be calculated using the control unit, assuming the mass of the vehicle is known, and after which the control unit is arranged to compare the calculated braking torque to the desired outgoing braking torque.

According to another preferred embodiment of the invention, the vehicle contains a further auxiliary brake, and the control unit is arranged to distribute the braking effect between the named main brake, named auxiliary brake, and named further auxiliary brake. The named further auxiliary brake can be in the form of an exhaust brake and a compression brake, for example. After a certain time and depending on the desired braking effect, the control unit can be arranged to distribute the braking effect only to the named auxiliary brake that comprises a retarder and the named further auxiliary brake, for example, either an exhaust brake or a compression brake, and the brake linings of the wheel brakes can thus be kept cold for emergency situations or when heavy braking is required. If the desired braking effect drops, the control unit can be arranged to distribute the largest braking effect to the exhaust brake.

The invention also relates to a braking system that comprises a device according to patent claims 1 to 11.

There are further properties and characteristics of the invention in the following description, the enclosed drawings, and other dependent patent claims.

### BRIEF DESCRIPTION OF THE DRAWINGS

Preferred embodiments of the invention are described below by way of examples with reference to the attached drawings, in which:

FIG. 1 shows schematically how the main brake and auxiliary brakes are arranged in a heavy vehicle, such as a truck,

FIG. 2 shows schematically a braking system according to the invention,

FIG. 3 illustrates schematically the braking process in FIG. 2 in the form of a graph diagram.

### DETAILED DESCRIPTION OF A PREFERRED EMBODIMENT OF THE INVENTION

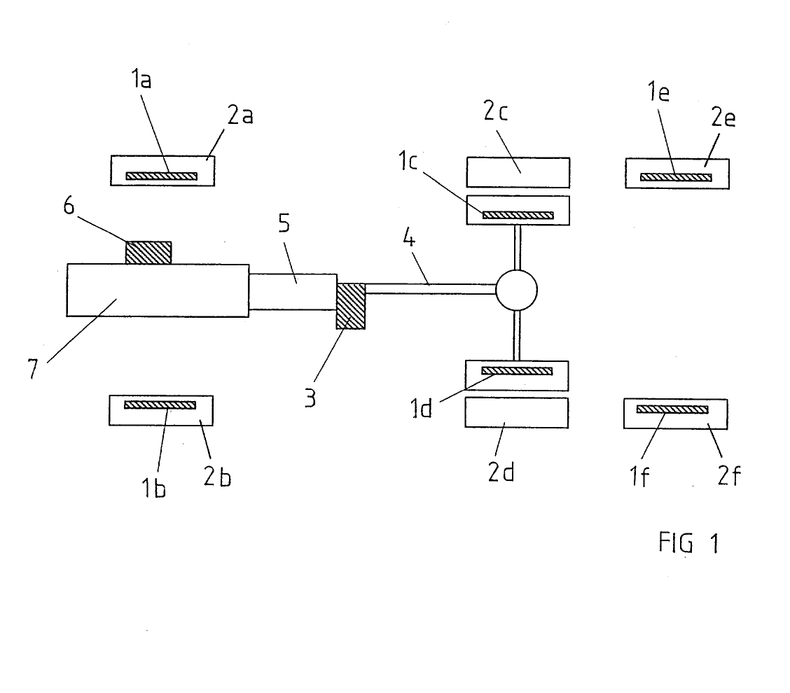

FIG. 1 depicts schematically the location of the available brakes on a heavy vehicle such as a truck. The vehicle contains a main brake, which includes braking devices 1a-f arranged to act on the vehicle wheels 2a-f. The braking devices 1a-f can consist of pneumatic disc brakes, and in this case the main brake comprises the equipment needed to press the brake pads of the respective disc brakes against the discs that rotate with the wheels 2a-f in question. The vehicle contains an auxiliary brake in the form of a retarder 3 that generates outgoing braking torque using viscous friction. The retarder 3 can be of the type described in the introductory description. The retarder 3 is thus connected to the propeller shaft 4 and to the vehicle gearbox 5 and brakes only the driven wheels 2c-d. The vehicle also contains a further auxiliary brake in the form of an exhaust brake 6. The exhaust brake 6 can be of the type described in the introductory description. The exhaust brake 6 is connected to the vehicle engine 7.

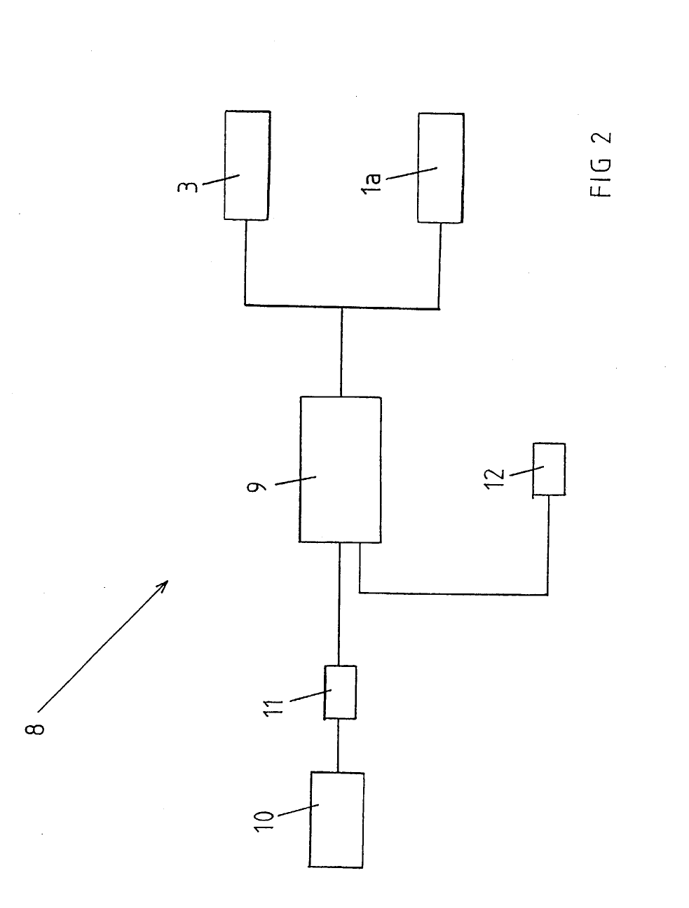

FIG. 2 depicts a braking system 8, according to a preferred embodiment of the invention, on a heavy vehicle such as a truck. The braking system comprises a control unit 9, the main brake and its braking devices 1a-f (only one braking device 1a is shown in FIG. 2), the retarder 3, and a brake control 10, with which both the brakes are activated. It should be noted that the braking system 8 could also include the exhaust brake 6. The braking system 8 comprises furthermore the first means of sensing 11 and the second means of sensing 12. The way the various parts of the braking system 8 in FIG. 2 work together is described in more detail below. It should be noted that the braking system 8 according to the invention is also applicable to other types of heavy vehicle such as, for example, other types of load-carrying vehicles, buses and similar commercial vehicles.

The brake control 10 can include a brake pedal (not shown) that can be moved by the driver's foot against the effect of a flexible force. The flexible force is proportional to the braking effect that the driver wishes to achieve. Thus the brake control 10 defines the desired braking effect, a so-called reference value. The sensor 11 is arranged to sense the named flexible force and to transmit a signal corresponding to the desired braking effect to the control unit 9, where the reference value is calculated. The control unit 9 includes a computer and when it receives a signal the control unit 9 is arranged to initiate activation of the main brakes 1a-f and the retarder 3 and distribute the braking effect between the main brakes with their braking devices 1a-f and the retarder 3. As it takes a certain time before the retarder 3 generates an outgoing braking torque, i.e. a braking effect, the control unit 9 is arranged to distribute essentially the whole of the braking effect to the main brake and its braking devices 1a-f during an initial period of activation. Furthermore, the control unit 8 is arranged to minimise the utilisation of the main brake with its braking devices 1a-f after the initial period with the object of preventing so-called heat fading, i.e. a reduction of the braking effect that occurs when the brake linings are very heated, and keeping the brake linings cold so that the braking devices are ready for heavy braking of the vehicle or panic braking. The braking process is controlled by a feedback and the control unit 9 is arranged to compare the vehicle's retardation to the desired retardation, i.e. the reference value. The sensor 12 can thus be arranged to sense the vehicle's retardation and transmit a signal to the control unit 9, equivalent to the retardation. The control unit 9 distributes the braking effect to the main brake and its braking devices 1a-f until the retarder 3 generates the desired braking effect by itself, i.e. the braking effect of the retarder 3 corresponds essentially to the reference value.

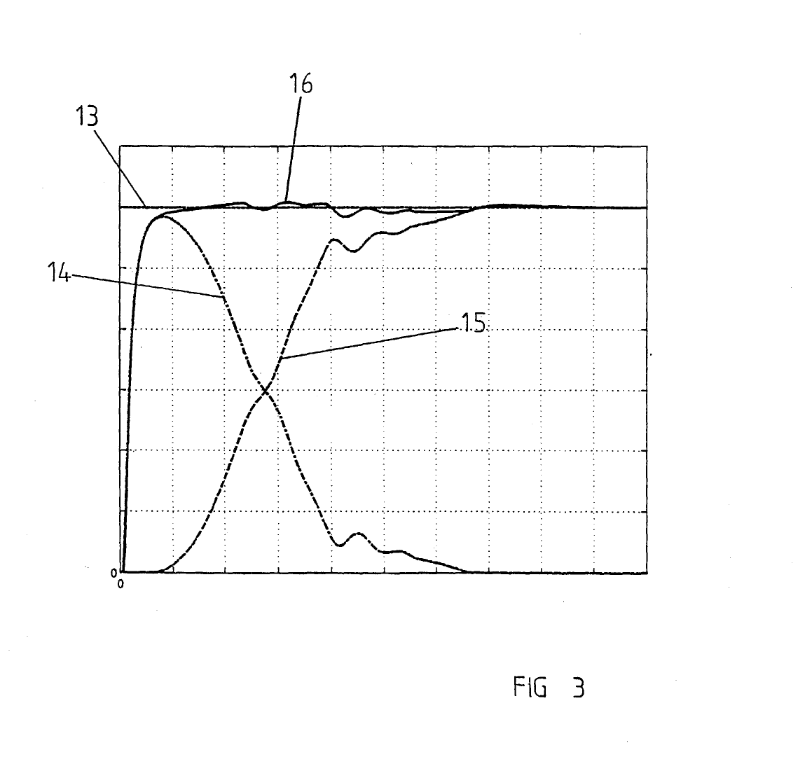

In FIG. 3 the braking process is illustrated in a graph diagram. The horizontal axis depicts time and the vertical axis depicts braking effect. The curve 13 corresponds to the desired braking effect i.e. the reference value, the curve 14 corresponds to the braking effect of the braking devices 1a-f, the curve 15 corresponds to the braking effect of the retarder 3, and the curve 16 corresponds to the total braking effect.

As the graphs show, the control unit 9 of the arrangement is arranged in such a way that the braking effect requested by the driver is obtained in the shortest possible time and in such a way that the use of the braking devices 1a-f of the main brake is minimised after the initial period. Initially, only the main brake and its braking devices 1a-f are responsible for the outgoing braking effect. But as the outgoing braking effect of the retarder 3 increases (curve 15), the braking effect of the main brake is reduced (curve 14). After a certain time the main brake is inactive and the retarder 3 alone is supplying the braking effect requested by the driver.

The invention is in no way limited to the embodiments described in the examples but may be modified freely within the scope of the following patent claims.

Patent claims

1. Arrangement for controlling a braking arrangement on a heavy vehicle, such as a truck for example, with a number of wheels that bear the vehicle, which braking arrangement comprises a main brake that includes braking devices (1a-f) that are each arranged to act on one of the named wheels (2a-f), at least one auxiliary brake (3) and at least one brake control (10) with which the named main brake (1a-f) and the named auxiliary brake (3) are activated, characterised in that the arrangement includes a control unit (9), which when the brake control (10) is activated, is arranged to initiate activation of the named main brake (1a-f) and the named auxiliary brake (3) and thus distribute the braking effect between the named main brake (1a-f) and the named auxiliary brake (3).

2. Arrangement according to claim 1, characterised in that the control unit (9) is arranged during an initial period of the named activation to distribute essentially the whole of the braking effect to the named braking devices (1a-f) of the main brake.

3. Arrangement according to claim 2, characterised in that the named control unit (9) is arranged in such a way that utilisation of the braking devices (1a-f) of the named main brake is minimised after the initial period.

4. Arrangement according to any one of the foregoing claims, characterised in that the control unit (9) is arranged in such a way that the sum of the braking effect from the named main brake (1a-f) and the braking effect from the named auxiliary brake (3) essentially corresponds to a reference value.

5. Arrangement according to claim 4, characterised in that the named brake control (10) is arranged to define the named reference value.

6. Arrangement according to claim 5, characterised in that the named brake control (10) is movable against the effect of a flexible force that is essentially proportional to the named reference value.

7. Arrangement according to any one of the claims 4 to 6, characterised in that the sensor (12) used to sense the vehicle's retardation and that the retardation is arranged to be fed back to the named control unit (9), where the control unit (9) is arranged to compare the vehicle's retardation to the named reference value.

8. Arrangement according to any one of the foregoing claims, characterised in that the control unit (9) is arranged when the named brake control (10) is activated to essentially simultaneously activate the named main brake (1a-f) and at least the named auxiliary brake (3).

9. Arrangement according to any one of the foregoing claims, characterised in that the named auxiliary brake (3) comprises a retarder that generates a braking torque using viscous friction.

10. Arrangement according to any one of the foregoing claims, characterised in that a further auxiliary brake (6) and that the control unit (9) is arranged to distribute the braking effect between the named main brake (1a-f), the named auxiliary brake (3), and the named further auxiliary brake (6).

11. Arrangement according to claim 10, characterised in that the named further auxiliary brake (6) comprises either an exhaust brake or a compression brake.

12. Braking system (8) for a heavy vehicle, such as a load-carrying vehicle for example, with a number of wheels (2a-f) that bear the vehicle, comprising a main brake that includes braking devices (1a-f) that are each arranged to act on one of the named wheels (2a-f), at least one auxiliary brake (3) and at least one brake control (10), with which the named main brake (1a-f) and the named auxiliary brake (3) are activated, characterised in that the braking system (8) comprises an arrangement according to any one of the patent claims 1-11.
